(19) United States
(12) Patent Application Publication
(10) Pub. No.: US 2003/0066977 A1
(43) Pub. Date: Apr. 10, 2003

(54) Optoelectronic distance measuring device

(75) Inventors: Johann Hipp, Hamburg (DE); Fried Gorris, Trittau (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch/Breisgau (DE)

(21) Appl. No.: 10/233,017

(22) Filed: Aug. 30, 2002

(30) Foreign Application Priority Data
Sep. 3, 2001 (DE) 101 43 061.2

(51) Int. Cl. G01N 21/86

(52) U.S. Cl. 250/559.38

(57) ABSTRACT

The invention relates to an optoelectronic distance measuring device, in particular to a laser scanner, comprising at least one transmitter unit for the transmission of pulsed electromagnetic radiation, at least one receiver unit associated with the transmitter unit for the reception of the reflected radiation and an evaluation device for the determination of the distance of the objects reflecting the transmitted radiation in accordance with a pulse transit time measuring process, with the evaluation device including at least two parallel transit time measuring channels and being made such that of two received pulses for the same transmitted pulse, in particular two successively arriving pulses on the same signal line, the earlier received pulse can be evaluated in the one measuring channel and the later received pulse can be evaluated in the other measuring channel, at least with respect to the transit time.

The invention relates to an optoelectronic distance measuring device, in particular to a laser scanner, having at least one transmitter unit for the transmission of pulsed electromagnetic radiation, at least one receiver unit associated with the transmitter unit for the reception of the reflected radiation and an evaluation unit for determining the distance of objects reflecting the radiation transmitted in accordance with a pulse transit time measuring process.

Such detection devices are generally known and are attached, for example, to vehicles to detect the environment of the vehicle during a journey.

Double echoes, i.e. echoes or reflections staggered time-wise, can occur due to the finite extent of the transmitted pulse if the transmitted pulse, also called a light bead, is only partly incident on a front object, or if the front object is permeable to the radiation used, so that a still sufficient amount of radiation is reflected by a rear object located at a greater distance. In these cases, a transmitted pulse results in two received pulses which reach the receiver unit successively time-wise.

The first, or front, object can, for example, be a raindrop, a snowflake or sawdust in a sawmill. If these objects are not of interest for the respective application, they then disturb the evaluation of the later received pulse originating from the actual object of interest, e.g. a vehicle traveling ahead of the device or a log in a sawmill. In other cases, the front objects can also be of interest in order to obtain statements, e.g. on the environmental conditions of the measuring device, with information on the objects further away, however, nevertheless being needed.

It is the object of the invention to provide an optoelectronic distance measuring device of the kind initially mentioned with which as much information as possible can be gained from the reflected radiation of an emitted transmitted pulse and with which, in particular, a plurality of received pulses of the transmitted pulse staggered in time can be evaluated with a precision which is as high as possible and can, in particular, be evaluated independent of one another.

This object is satisfied by the features of claim 1, and in particular in that the evaluation device includes at least two parallel transit time measuring channels and is designed such that of two successively incoming received pulses for the same transmitted pulse, in particular successively incoming pulses on the same signal line, the earlier received pulse can be evaluated in the one measuring channel and the later received pulse can be evaluated in the other measuring channel, at least with respect to the transit time.

In accordance with the invention, at least two parallel receiver channels are provided. Received pulses of the same transmitted pulse arriving successively time-wise can hereby be evaluated with high precision and independently of one another. This is in particular possible for received pulses arriving successively in time on the same signal line.

A changeover can preferably be made by means of an automatic switching process from the one measuring channel provided for the evaluation of the earlier received pulse to the other measuring channel provided for the evaluation of the later received pulse.

In this way it is automatically ensured that the later received pulse enters into a different measuring channel from the earlier received pulse and that it does not block the evaluation unit.

It is particularly preferred for the switching process to be triggered by means of the earlier received pulse.

In this arrangement it is actually the earlier received pulse itself which ensures that it does not block the evaluation device for the later received pulse, but more or less “clears” the way into the other measuring channel.

The device in accordance with the invention is preferably made such that time measurements can be started in both measuring channels by means of the transmitted pulse, with time measurements in the one measuring channel being capable of being terminated by means of the earlier received pulse and in the other measuring channel by means of the later received pulse.

In this connection, it is preferred for a respective time measurement to be started in each measuring channel by means of the front flank and the rear flank of the transmitted pulse, with the earlier time measurement being terminated by means of the front flank of the relevant received pulse and the later time measurement being terminated by means of its rear flank.

To start and end the time measurements, provision is preferably made for gates to be opened and closed in the evaluation device by means of the pulse flanks of the start pulse and of the received pulses. This takes place in particular in a logic unit of the evaluation device.

A time-to-analog converter is preferably provided for the evaluation of the widths of the gates. The gate widths corresponding to the times measured are hereby converted into analog signals for further processing.

The time-to-analog converter is preferably followed by an analog/digital converter as well as a microprocessor connected to it with which the distances at which the received pulses were reflected can be determined from the pulse transit times measured.

The use of a plurality of parallel measured channels in accordance with the invention can generally be utilized for any desired number of received pulses of the same transmitted pulse. In this connection, a separate measuring channel can be provided for every received pulse in dependence on the number of received pulses expected or required for the respective application.

Further preferred embodiments of the invention are also set forth in the dependent claims, the description and the drawing.

The invention will be described in the following by way of example with reference to the drawing. There are shown:

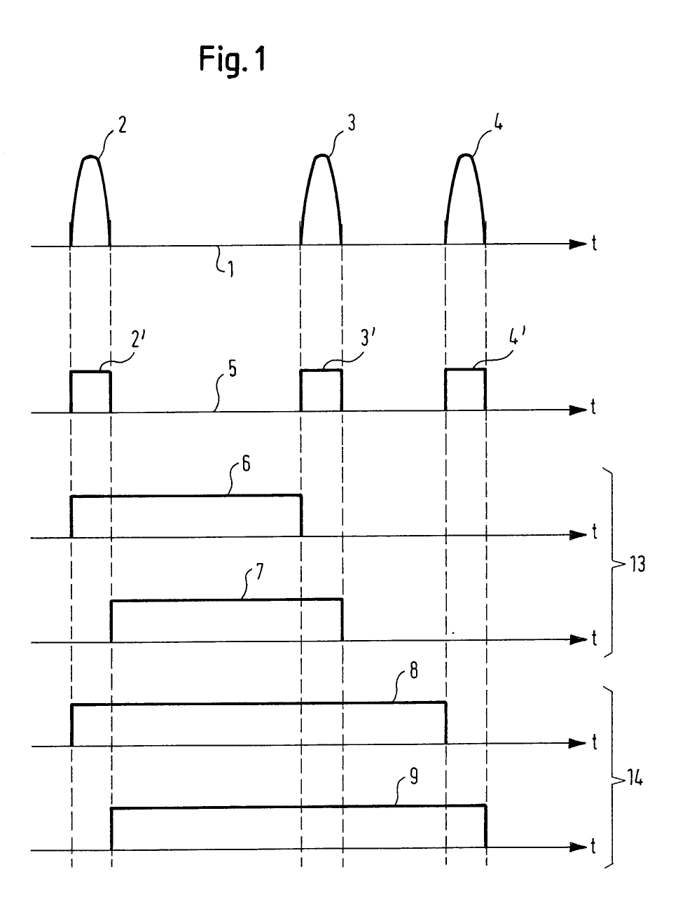

FIG. 1 transmitted pulses and received pulses as well as gates of an optoelectronic distance measuring device formed therefrom in accordance with an embodiment of the invention;

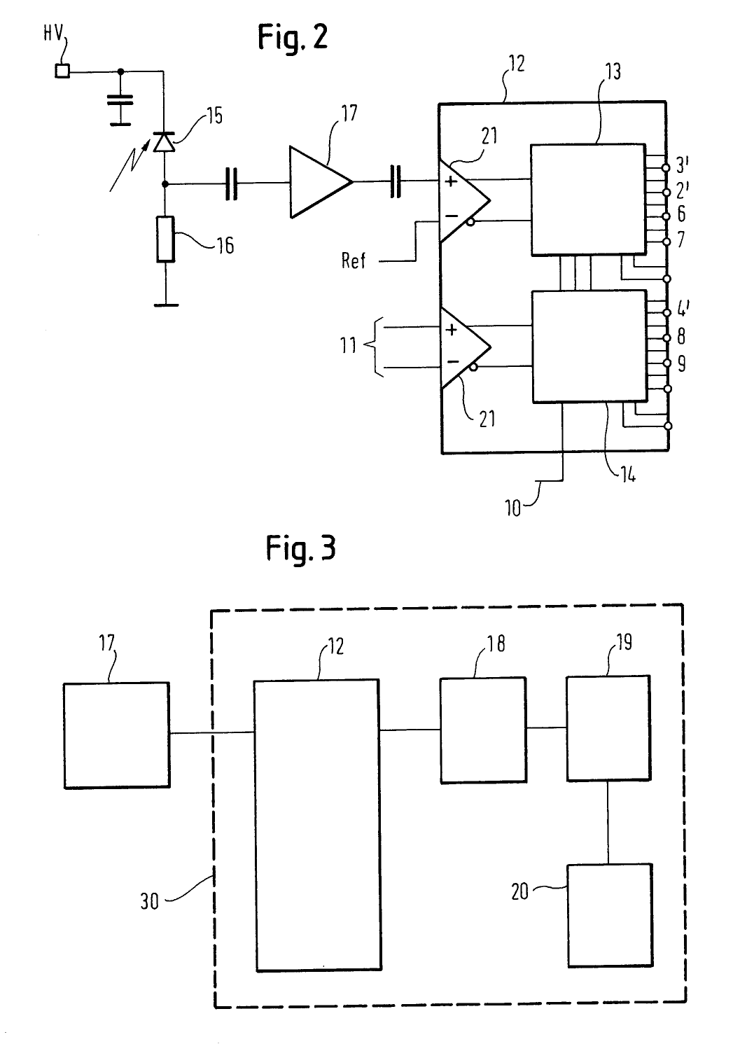

FIG. 2 the circuit diagram for a receiver unit and a part of an evaluation device of an optoelectronic distance measuring device in accordance with an embodiment of the invention;

FIG. 3 a schematic representation of an evaluation device of an optoelectronic distance measuring device in accordance with an embodiment of the invention.

The optoclectronic measuring device in accordance with the invention is preferably a laser scanner which transmits pulsed electromagnetic radiation into a monitored zone in one or more scanning planes and receives radiation reflected by objects located in the monitored zone. The transmitter unit includes, as a radiation source, a laser diode and a radiation deflection device in the form of a rotating mirror. The field of view of such a scanner amounts to up to 360°. A photodiode, in particular an avalanche photodiode (APD) is provided as a receiver for each scanning plane. Within each scanning plane, the scanner also measures the angle with respect to a pre-determined axis—in addition to the distance from one or more objects (which will be discussed in more detail in the following)—for every direction in which a transmitted pulse is transmitted.

FIG. 1 first shows, for the example of a scanning plane of the scanner—from the top to the bottom—the analog received signal 1 which is supplied from the photo diode 15 connected in series with a load resistor 16 (cf. FIG. 2) and from a downstream amplifier 17 and which includes two received pulses 3, 4 which are received after the transmission of the transmitted pulse 2 at times depending on the distance from the objects in question at which the radiation was respectively reflected.

The pulses are digitized by means of a comparator 21 having a predetermined reference voltage. The comparator 21, as well as two separate, parallel measuring modules 13, 14, are components of a logic unit 12 of an evaluation unit 30 (cf. FIG. 3) of the scanner. The measuring modules 13, 14, form two parallel measuring channels of the evaluation device.

The digitized transmitted pulse 2′ starts two respective time measurements in both measuring modules 13, 14 in that gates 6, 7, 8, 9 are opened both by means of its front flank and by means of its rear flank.

The digitized received pulses 3′, 4′ enter into the one measuring module 13 successively in time, i.e. in time sequence. In this measuring module 13, the front flank of the earlier received pulse 3′ ends the time measurement begun first and its rear flank ends the time measurement begun last by closing the corresponding gates 6, 7, as shown in FIG. 1 for the individual switching processes.

Moreover, a switching process is triggered by the rear flank of the earlier received pulse 3′, whereby subsequent pulse flanks act on the other measuring module 14. Consequently, the gates 8, 9 in the other measuring module 14 which are still open after the arrival of the earlier received pulse 3′ are closed by the front flank and the rear flank of the later received pulse 4′, i.e. the time measurements in this second measuring channel 14, which were still running up to then, are likewise terminated.

The later received pulse 4′ is hereby more or less deflected onto the other measured channel 14 by the earlier received pulse 3′ to end the time measurements running there.

The results are consequently four gate widths, i.e. four times from which the transit times of the received pulses 3, 4, can be determined. For this purpose, the evaluation device 30 includes a time-to-analog converter (TAC) 18 (cf. FIG. 3) downstream of the logic unit 12 with which the times corresponding to the gate widths are first converted into analog signals from which subsequently processable digital signals are produced by means of an analog/digital converter 19 with a subsequent microprocessor 20.

The microprocessor 20 calculates the transit time of the relevant received pulse 3, 4—and thus the distance from the respective object at which the reflection of the transmitted pulse 2 took place—for each measuring channel 13, 14 from half the sum of the relevant gate widths.

In accordance with the invention, the distances of two objects arranged in a staggered manner, at which this transmitted pulse 2 is successively reflected time-wise, can thus be determined for every single transmitted pulse 2, i.e. for every “shot” of the scanner, by independent evaluation of the relevant received pulses 3, 4 arriving successively time-wise.

In FIG. 2, a further input 11 is shown only by way of example which is formed by another comparator 21 connected to the other measuring module 14. In a preferred embodiment, the laser scanner in accordance with the invention transmits radiation in a plurality of scanning planes, and in particular in four scanning planes, with a receiver unit having a photodiode 15 and an amplifier 17 being provided for each scanning plane. Such a further second receiver unit can be connected to the input 11.

The other measuring module 14 furthermore has a select input 10 with which the function in accordance with the invention for the measurement of double pulses incoming in a staggered manner can be switched over to the function of two independent distance measurers working in parallel for the measurement of the respectively first echo pulse.

### REFERENCE NUMERAL LIST

1 analog received signal

2/2′ analog/digitized transmitted pulse

3/3′ analog/digitized early received pulse

4/4′ analog/digitized late received pulse

5 digital received signal

6, 7, 8, 9 gate

10 select input

11 input for further distance measuring device

12 logic unit

13 module for first measuring channel

14 module for second measuring channel

15 photodiode (APD)

16 load resistor

17 amplifier

18 time-to-analog converter (TAC)

19 analog/digital converter (ADC)

20 microprocessor

21 comparator

30 evaluation device

1. An optoelectronic distance measuring device, in particular a laser scanner, comprising
at least one transmitter unit for the transmission of pulsed electromagnetic radiation;
at least one receiver unit (15, 16) associated with the transmitter unit for the reception of the reflected radiation; and
an evaluation device (30) for the determination of the distance of objects reflecting the transmitted radiation in accordance with a pulse transit time measuring process,
wherein the evaluation device (30) includes at least two parallel transit time measuring channels (13, 14) and is made such that of two successively incoming received pulses (3, 3′, 4, 4′) for the same transmitted pulse (2, 2′), in particular successively incoming pulses on the same signal line, the earlier received pulse (3, 3′) can be evaluated in the one measuring channel (13) and the later received pulse (4, 4′) can be evaluated in the other measuring channel (14), at least with respect to the transit time.

2. A device in accordance with claim 1, characterized in that a switch can be made by means of an automatic switching over process from the one measuring channel (13) provided for the evaluation of the earlier received pulse (3, 3′) to the other measuring channel (14) provided for the evaluation of the later received pulse (4, 4′).

3. A device in accordance with claim 2, characterized in that the switching over can be triggered by means of the earlier received pulse (3, 3′).

4. A device in accordance with claim 1, characterized in that time measurements can be started in both measuring channels (13, 14) by means of the transmitted pulse (2, 2′), with time measurements being capable of being terminated by means of the earlier received pulse (3, 3′) in the one measuring channel (13) and by means of the later received pulse (4, 4′) in the other measuring channel (14).

5. A device in accordance with claim 4, characterized in that a respective time measurement can be started in each measuring channel (13, 14) by means of the front flank and of the rear flank of the transmitted pulse (2, 2′), with the earlier time measurement being capable of being terminated by means of the front flank of the relevant received pulse (3, 3′, 4, 4′) and the later time measurement by means of its rear flank.

6. A device in accordance with claim 4, characterized in that, for the time measurements in the evaluation device (30), in particular in a logic unit (12), provision is made for the opening and closing of gates (6, 7, 8, 9) by means of the pulse flanks of the start pulse (2, 2′) and of the received pulses (3, 3′, 4, 4′).

7. A device in accordance with claim 1, characterized in that a time-to-analog converter (18) is provided for the evaluation of the widths of the gates (6, 7, 8, 9).

8. A device in accordance with claim 1, characterized in that an analog/digital converter (19) and a microprocessor (20) are disposed after the time-to-analog converter (18) for the determination of the distances from the pulse transit times measured.
